(19) United States
(12) Patent Application Publication
(10) Pub. No.: US 2011/0163010 A1
(43) Pub. Date: Jul. 7, 2011

(54) METHOD AND APPARATUS FOR RECOVERING HYDROGEN IN A PETROLEUM-BASED HYDROCARBON DESULFURIZATION PROCESS

(75) Inventors: In Sul Lee, Seoul (KR); Hee Jo Kim, Seoul (KR); Kug Kyong Song, Ulsan (KR); Gwang Bin Moon, Ulsan (KR)

(73) Assignees: SK INNOVATION CO., LTD., Seoul (KR); SK ENERGY CO., LTD., Seoul (KR)

(21) Appl. No.: 13/058,892

(22) PCT Filed: Aug. 10, 2009
(86) PCT No.: PCT/KR2009/004437

§ 371 Date: Mar. 23, 2011

(30) Foreign Application Priority Data
Aug. 14, 2008 (KR) 10-2008-0079800

(51) Int. Cl. C10G 45/00; B01J 8/00

(52) U.S. Cl. 208/210; 422/187

(57) ABSTRACT

Disclosed herein is a method and apparatus for recovering hydrogen in the process of desulfurizing petroleum hydrocarbon, in which hydrogen is recovered from the fuel fraction obtained by hydrodesulfurization, and the recovered hydrogen is reused, so that the existing hydrodesulfurization equipment for producing ultralow-sulfur diesel fuel can be utilized to the utmost and simultaneously the effluence of hydrogen from fuel fraction can be minimized, thereby reducing production costs.

### RELATED APPLICATIONS

This is a §371 of International Application No. PCT/KR2009/004437, with an international filing date of Aug. 10, 2009 (WO 2010/018954, published Feb. 18, 2010), which is based on Korean Patent Application No. 10-2008-0079800 filed Aug. 14, 2009.

### TECHNICAL FIELD

The present disclosure relates to a method of recovering hydrogen used in the desulfurization process of petroleum hydrocarbon and an apparatus for producing ultralow-sulfur diesel fuel using the method. More particularly, the present disclosure relates to a method and apparatus for recovering hydrogen in a process of desulfurizing petroleum hydrocarbon, in which hydrogen is recovered from the fuel fraction obtained by hydrodesulfurization, and the recovered hydrogen is reused, so that the existing hydrodesulfurization equipment for producing ultralow-sulfur diesel fuel can be utilized to the utmost and simultaneously the effluence of hydrogen from a fuel fraction can be minimized, thereby reducing production costs.

### BACKGROUND

When petroleum containing a large amount of sulfur is fractionated by atmospheric distillation, various petroleum products, such as gasoline, lamp oil (kerosene), light oil (diesel oil), lube oil, heavy oil and the like, are obtained. All of these petroleum products contain sulfur compounds, and, particularly, contain a larger amount of sulfur compounds as they approximate heavy oil. Gasoline containing a large amount of sulfur does not have good inflammability. Further, Lamp oil, light oil and heavy oil containing a large amount of sulfur produce sulfur dioxide gas in the combustion gas to cause air pollution.

As methods of desulfurizing such petroleum products, conventionally, a method of washing petroleum products with a sulfuric acid aqueous solution or a sodium hydroxide aqueous solution, a method of bringing petroleum products into contact with acidic white clay to adsorb sulfur, and the like have been used. However, these methods are problematic in that sulfur is insufficiently removed, and loss from refining is increased. Recently, a hydrodesulfurization method has been widely used. In this hydrodesulfurization method, mercaptans, chained sulfur compounds and cyclic sulfur compounds, which are sulfur compounds existing in petroleum fractions, are reacted with hydrogen using catalysis at high temperature and pressure to decompose sulfur compound molecules, thus separating these sulfur compounds into hydrogen carbide and hydrogen sulfide. This hydrodesulfurization method has exhibited excellent sulfur removal effects to such a degree that the content of sulfur in the petroleum product is decreased to 0.1 wt %.

Recently, worldwide, as the regulation of sulfur content in fuel has become strict, the necessity for ultralow-sulfur diesel fuel which contains in amount of 10 ppm or less has been emphasized. Therefore, in order to produce ultralow-sulfur diesel fuel, new desulfurization technologies based on adsorption, solvent extraction or the like have been developed. However, these new desulfurization technologies are problematic in that operation costs are increased by the excessive consumption of hydrogen, and in that large-scale investment, such as the reconstruction of the existing desulfurization equipment, the introduction of new process equipment, or the like, are required.

Therefore, currently, most oil refining companies are producing ultralow-sulfur diesel fuel containing sulfur in a concentration of 10 ppm or less by controlling process variables, such as desulfurizing catalyst temperature, pressure, reaction rate and the like, while directly using the existing desulfurization equipment.

However, as shown in FIG. 1, the conventional hydrodesulfurization process for producing ultralow-sulfur diesel fuel is performed by the steps of: separating the hydrocarbon fraction having passed through a desulfurizer 12 into a fuel fraction, which is a tower-bottom fraction, and a mixed gas of hydrogen and hydrogen sulfide using a high-pressure separator 13; passing the mixed gas through a hydrogen sulfide absorbing tower to remove hydrogen sulfide therefrom, compressing the mixed gas using a compressor 17 and then recirculating the compressed mixed gas; and transferring the fuel fraction to a stripper 18 to remove hydrogen sulfide (H₂S). However, since this conventional hydrodesulfurization process is conducted under the conditions of a high pressure of 50 kg/cm² or more, low LHSV (amount of diesel fuel treated per 1 m³ of catalyst) and high hydrogen partial pressure, and a high-pressure separator provided at the rear end of a hydrodesulfurizer is also operated under the condition of high pressure, there is a problem in that the solubility of hydrogen increases, so that a large amount of hydrogen dissolves in the tower-bottom fraction of the high-pressure separator and is then discharged, and the discharged hydrogen is directly used as fuel gas, thereby deteriorating the grade of quality of the hydrogen. That is, this conventional hydrodesulfurization process is problematic in that expensive hydrogen is discharged and then mixed with cheap fuel gas and then used, thus increasing the total production cost.

### SUMMARY

Accordingly, the present disclosure provides a method and apparatus for recovering hydrogen in the process of desulfurizing petroleum hydrocarbon, which can utilize the existing hydrodesulfurization equipment for producing ultralow-sulfur diesel fuel to the utmost and simultaneously can minimize the effluence of hydrogen from the fuel fraction obtained by a hydrodesulfurization process.

The present disclosure shows a method and apparatus for recovering hydrogen dissolved in petroleum hydrocarbon fraction by sequentially passing the petroleum hydrocarbon fraction discharged from the rear end of a high-pressure separator installed in a desulfurizer through a low-pressure separator, a low-temperature separator and a hydrogen sulfide absorbing tower to separate hydrogen from the hydrocarbon fraction and then recirculating the separated hydrogen.

Therefore, the present disclosure provides a method and apparatus for recovering hydrogen in the process of desulfurizing petroleum hydrocarbon, which can reduce production costs by minimizing the effluence of hydrogen from the fuel fraction obtained by a hydrodesulfurization process.

Further, the present disclosure provides a method and apparatus for recovering hydrogen in the process of desulfurizing petroleum hydrocarbon, which can reduce production costs by directly utilizing the existing hydrodesulfurization equipment and simultaneously minimizing the effluence of hydrogen used in a desulfurization process.

According to the present disclosure, a low-pressure separator, a low-temperature separator, a hydrogen sulfide absorbing tower and a hydrogen recovery pipe are sequentially disposed at the rear end of a high-pressure separator in the hydrodesulfurization process, and the hydrogen discharged from the hydrogen sulfide absorbing tower is recovered, so that the hydrogen included in the petroleum hydrocarbon fraction obtained by a hydrodesulfurization process can be separated, recovered and then reused, with the result that the production costs caused by the mixing of expensive hydrogen and inexpensive petroleum hydrocarbon fraction can be minimized, and ultralow-sulfur diesel fuel can be produced at low cost, thereby strengthening the competitiveness.

### BRIEF DESCRIPTION OF THE DRAWINGS

FIG. 1 is a schematic view showing a conventional hydrodesulfurization process; and

FIG. 2 is a schematic view showing a process of recovering hydrogen using a hydrodesulfurization process according to the present disclosure.

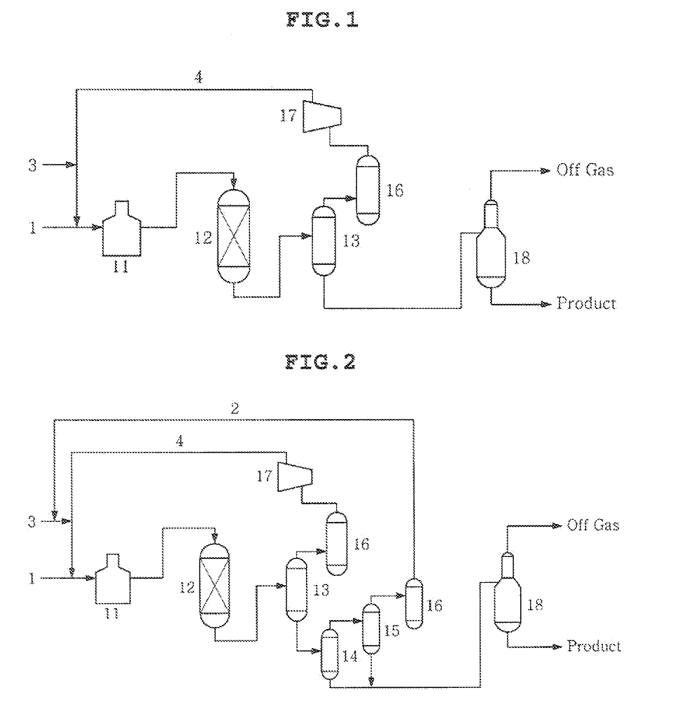

### DESCRIPTION OF THE ELEMENTS IN THE DRAWINGS

1. petroleum hydrocarbon
2, 4. recirculated hydrogen
3. replenished hydrogen
11. heating furnace
12. desulfurizer
13. high-pressure separator
14. low-pressure separator
15. low-temperature separator
16. hydrogen sulfide absorbing tower
17. compressor
18. stripper
19. compressor for replenishing hydrogen

### DETAILED DESCRIPTION

An embodiment of the present disclosure provides a method of recovering hydrogen in a process of desulfurizing petroleum hydrocarbon, including: removing sulfur from a mixture of petroleum hydrocarbon and hydrogen using a desulfurizer; separating the mixture into a petroleum hydrocarbon fraction and a hydrogen mixture using a high-pressure separator; passing the petroleum hydrocarbon fraction through a low-pressure separator to separate it into ultralow-sulfur petroleum hydrocarbon and a mixture of hydrogen and hydrogen sulfide; passing the mixture of hydrogen and hydrogen sulfide through a low-temperature separator to separate a light oil fraction in the mixture; passing the remaining mixture of hydrogen and hydrogen sulfide, from which the light oil fraction was separated, through a hydrogen sulfide absorbing tower to obtain hydrogen; and recirculating the hydrogen obtained by the hydrogen sulfide absorbing tower.

Another embodiment of the present disclosure provides an apparatus for recovering hydrogen in a process of desulfurizing petroleum hydrocarbon, including: a desulfurizer removing sulfur from a mixture of petroleum hydrocarbon and hydrogen; a high-pressure separator separating the mixture into a petroleum hydrocarbon fraction and a hydrogen mixture; a low-pressure separator through which the petroleum hydrocarbon fraction is passed to separate it into ultralow-sulfur petroleum hydrocarbon and a mixture of hydrogen and hydrogen sulfide; a low-temperature separator through which is passed the mixture of hydrogen and hydrogen sulfide to separate a light oil fraction in the mixture; a hydrogen sulfide absorbing tower through which the remaining mixture of hydrogen and hydrogen sulfide is passed, from which the light oil fraction was separated, to obtain hydrogen; and an apparatus recirculating the hydrogen obtained by the hydrogen sulfide absorbing tower.

Hereinafter, preferred embodiments of the present disclosure will be described in detail with reference to the accompanying drawings.

As shown in FIG. 2, the method of removing hydrogen according to the present disclosure is a novel method of separating and recovering hydrogen included in a petroleum hydrocarbon fraction having undergone a hydrodesulfurization process by sequentially disposing a low-pressure separator 14, a low-temperature separator 15, a hydrogen sulfide absorbing tower 16 and a hydrogen recovery pipe at the rear end of a high-pressure separator 13 in a hydrodesulfurization process for producing ultralow-sulfur diesel fuel.

The method of recovering hydrogen in the hydrodesulfurization process according to the present disclosure, shown in FIG. 2, is described as follows.

In FIG. 2, petroleum hydrocarbon 1, which is the major raw material for the desulfurization process, may be lamp oil, light oil or diesel oil having a boiling point of 180˜450° C., and has a sulfur content of about 2,000˜15,000 ppm. Petroleum hydrogen 1 is mixed with hydrogen and then passes through a heating furnace 11 to be previously heated to a temperature of 280˜360° C., which is a temperature necessary for desulfurization. In this case, in order to heat the mixture of petroleum hydrocarbon and hydrogen, one or more heat exchangers may be additionally provided.

The heated mixture of petroleum hydrocarbon and hydrogen is supplied to a desulfurizer 12. The desulfurizer 12 is charged with NiMo and/or CoMo catalyst which is used for deep desulfurization, and the pressure in the desulfurizer 12 is 40˜80 kg_{f}/cm². The content of sulfur in the petroleum hydrocarbon having passed through the desulfurizer 12 is very low. That is, this petroleum hydrocarbon has a sulfur content of 10 ppm or less, except for hydrogen sulfide (H₂S).

The mixture of hydrogen and petroleum hydrocarbon, the sulfur content of which is greatly reduced by the desulfurizer 12, passes through a high-pressure separator 13 to be separated into a mixed gas of hydrogen and hydrogen sulfide and petroleum hydrocarbon fraction containing hydrogen. The high-pressure separator 13 is operated under the conditions of a temperature of 200˜260° C. and a pressure of 35˜75 kg_{f}/cm². The mixed gas of hydrogen and hydrogen sulfide, separated through the top of the high-pressure separator 13, passes through a hydrogen sulfide absorbing tower charged with amine to remove hydrogen sulfide from the mixture by adsorption, and is then compressed by a compressor 17 and then recirculated. Meanwhile, since the high-pressure separator 13 is operated under the condition of high pressure, the solubility of hydrogen increases, so that the ultralow-sulfur petroleum hydrocarbon, which corresponds to the fraction placed at the bottom of the high-pressure separator 13, includes a large amount of hydrogen, and this ultralow-sulfur petroleum hydrocarbon containing a large amount of hydrogen is discharged through the bottom of the high-pressure separator 13.

Therefore, in the present disclosure, in order to recover hydrogen from the hydrogen-containing petroleum hydrocarbon discharged from the bottom of the high-pressure separator 13, the hydrogen-containing petroleum hydrocarbon fraction is passed through a low-pressure separator 14. The low-pressure separator 14 serves to separate hydrogen by creating a low-pressure atmosphere such that the hydrogen dissolved in petroleum hydrocarbon as a result of the high-pressure condition of the high-pressure separator 13 disposed at the front end of this low-pressure separator 14 is vaporized into the form of a gas. The optimal operation of the low-pressure separator 14 for separating a maximum of hydrogen may be conducted under the conditions of a temperature of 200˜260° C. and a pressure of 25˜35 kg_{f}/cm².

The mixed gas of hydrogen and hydrogen sulfide separated from the low-pressure separator 14 passes through a low-temperature separator 15. The gas mixture separated from the top of the low-pressure separator 14 includes a very small amount of petroleum hydrocarbon in addition to hydrogen and hydrogen sulfide. When this gas mixture passes through the low-temperature separator 15, petroleum hydrocarbon having a relatively high due point is condensed in the form of liquid to separate this petroleum hydrocarbon from the gas mixture. Therefore, the mixed gas of hydrogen and hydrogen sulfide is discharged from the top of the low-temperature separator 15, and the petroleum hydrocarbon fraction is discharged from the bottom thereof. The optimal operation of the low-temperature separator 15 may be conducted under the conditions of a temperature of 38˜50° C. and a pressure of 25˜35 kg_{f}/cm².

The mixed gas of hydrogen and hydrogen sulfide discharged from the top of the low-temperature separator 15 is introduced into a hydrogen sulfide absorbing tower 16 charged with an amine. When hydrogen containing hydrogen sulfide is reused in a desulfurization process, the hydrogen sulfide causes the corrosion of apparatuses such as a compressor and the like and hinders the hydrodesulfurization reaction from taking place in the desulfurization process. Therefore, the hydrogen sulfide absorbing tower 16 serves to recover and reuse only the pure hydrogen by allowing the adsorbent to adsorb hydrogen sulfide. Examples of the adsorbent may include, but are not limited to, an amine, ammonia, sodium hydroxide, calcium hydroxide and the like, preferably, amine.

The hydrogen 2 recovered by the hydrogen sulfide absorbing tower 16 is transferred to the inlet pipe of a compressor 17 for replenishing hydrogen, and is then further mixed with the recirculated hydrogen 4 recirculated from the top of the high-pressure separator 13 with combining replenished hydrogen 3, and is then recirculated together with the petroleum hydrocarbon 1.

Hereinafter, the present disclosure will be described in more detail with reference to the following Example. However, the scope of the present disclosure is not limited thereto.

### Example 1

As shown in FIG. 2, the yearly hydrogen consumption and cost for using hydrogen occurring when ultralow-sulfur diesel fuel is produced using the method and apparatus for recovering hydrogen by sequentially disposing a low-pressure separator, a low-temperature separator, a hydrogen sulfide absorbing tower and a hydrogen recovery pipe at the rear end of a high-pressure separator in the hydrodesulfurization process according to the present disclosure were compared with those occurring when ultralow-sulfur diesel fuel is produced using conventional technology. The results thereof are given in Table 1 below:

TABLE 1

| | Comparative | | |
|---|---|---|---|
| | Example | Example | |
| | (prior art) | 1* | Decrement |
| Yearly hydrogen | 43,618 | 41,340 | 2,278 Reduction |
| consumption, nm3/h | | | |
| Cost for using hydrogen, | 839 | 795 | 44 Reduction |
| billion won/year | | | |

*Results of process operation of SK energy No. 6MDU, hydrogen 229 won/nm 3, 350 days/year

As given in Table 1 above, when ultralow-sulfur diesel fuel was produced using the method and apparatus for recovering hydrogen by sequentially disposing a low-pressure separator, a low-temperature separator, a hydrogen sulfide absorbing tower and a hydrogen recovery pipe at the rear end of a high-pressure separator 13 in the hydrodesulfurization process according to the present disclosure, the cost of expensive hydrogen, occupying 50% or more of the production cost in the process of producing ultralow-sulfur diesel fuel, was greatly reduced to 5% or more.

The foregoing examples and embodiments are provided merely for the purposes of illustration and explanation and are in no way to be construed as limiting. While reference to various embodiments are shown, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

1. A method of recovering hydrogen in a process of desulfurizing petroleum hydrocarbon, comprising:
removing sulfur from a mixture of petroleum hydrocarbon and hydrogen using a desulfurizer;
separating the mixture into a petroleum hydrocarbon fraction and a hydrogen mixture using a high-pressure separator;
passing the petroleum hydrocarbon fraction through a low-pressure separator to separate it into ultralow-sulfur petroleum hydrocarbon and a mixture of hydrogen and hydrogen sulfide;
passing the mixture of hydrogen and hydrogen sulfide through a low-temperature separator to separate a light oil fraction in the mixture;
passing the remaining mixture of hydrogen and hydrogen sulfide, from which the light oil fraction was separated, through a hydrogen sulfide absorbing tower to obtain hydrogen; and
recirculating the hydrogen obtained by the hydrogen sulfide absorbing tower.

2. The method according to claim 1, wherein the low-pressure separator is operated at a pressure of 25˜35 kg_{f}/cm² and a temperature of 200˜260° C.

3. The method according to claim 1, wherein the low-temperature separator is operated at a temperature of 38˜50° C. and a pressure of 25˜35 kg_{f}/cm².

4. The method according to claim 1, wherein the petroleum hydrocarbon is lamp oil, light oil or diesel oil having a boiling point of 180˜450° C.

5. The method according to claim 1, wherein the petroleum hydrocarbon having passed through the desulfurizer has a sulfur content of 10 ppm or less.

6. An apparatus for recovering hydrogen in a process of desulfurizing petroleum hydrocarbon, comprising:
a desulfurizer removing sulfur from a mixture of petroleum hydrocarbon and hydrogen;
a high-pressure separator separating the mixture into a petroleum hydrocarbon fraction and a hydrogen mixture;
a low-pressure separator through which the petroleum hydrocarbon fraction is passed to separate it into ultralow-sulfur petroleum hydrocarbon and a mixture of hydrogen and hydrogen sulfide;
a low-temperature separator through which the remaining mixture of hydrogen and hydrogen sulfide is passed to separate a light oil fraction in the mixture;
a hydrogen sulfide absorbing tower through which the mixture of hydrogen and hydrogen sulfide, from which the light oil fraction was separated, is passed to obtain hydrogen; and
an apparatus recirculating the hydrogen obtained by the hydrogen sulfide absorbing tower.

7. The apparatus according to claim 6, wherein the low-pressure separator is operated at a pressure of 25˜35 kg_{f}/cm² and a temperature of 200˜260° C.

8. The apparatus according to claim 6, wherein the low-temperature separator is operated at a temperature of 38˜50° C. and a pressure of 25˜35 kg_{f}/cm².

9. The apparatus according to claim 6, wherein the petroleum hydrocarbon is lamp oil, light oil or diesel oil having a boiling point of 180˜450° C.

10. The apparatus according to claim 6, wherein the petroleum hydrocarbon having passed through the desulfurizer has a sulfur content of 10 ppm or less.
